(19) United States
(12) Patent Application Publication
(10) Pub. No.: US 2012/0056544 A1
(43) Pub. Date: Mar. 8, 2012

(54) APPARATUS FOR DRIVING LIGHT EMITTING DEVICE

(75) Inventors: Nak Jun JEONG, Hwaseong (KR); Jae Eun Kim, Seoul (KR); Jong Duck Kim, Suwon (KR); Kwang Hee Sung, Suwon (KR)

(73) Assignee: SAMSUNG ELECTRO-MECHANICS CO., LTD.

(21) Appl. No.: 13/227,123

(22) Filed: Sep. 7, 2011

(30) Foreign Application Priority Data
Sep. 8, 2010 (KR) 10-2010-0087847

(51) Int. Cl. H05B 37/02

(52) U.S. Cl. 315/121; 315/293

(57) ABSTRACT

An apparatus for driving a light emitting device includes: a current control unit generating a current control signal according to a preset current setting value; a constant current circuit unit varying a current resistance value according to the current control signal of the current control unit, detecting a current flowing in a light emitting unit including a plurality of emitting devices by using the current resistance value, and controlling the current flowing in the light emitting unit based on the detected current; and a voltage control unit varying a voltage resistance value according to a preset voltage setting value, detecting a voltage supplied to the light emitting unit by using the voltage resistance value, and determining whether or not the voltage is in an over-voltage state, based on the detected voltage.

### CROSS-REFERENCE TO RELATED APPLICATIONS

This application claims the priority of Korean Patent Application No. 10-2010-0087847 filed on Sep. 8, 2010, in the Korean Intellectual Property Office, the disclosure of which is incorporated herein by reference.

### BACKGROUND OF THE INVENTION

1. Field of the Invention

The present invention relates to an apparatus for driving a light emitting device which is applicable to a light emitting diode (LED) system, and more particularly, to an apparatus for driving a light emitting device which is capable of externally controlling an over-voltage protection (OVP) reference voltage of a light emitting device such as an LED and a current flowing in the light emitting device by setting the voltage and current of the light emitting device from the outside.

2. Description of the Related Art

In general, an LED driving circuit according to the related art uses a single setting pin for an LED output current and an OVP voltage, in order to set the LED output current and the OVP voltage. As such, the LED driving circuit operates according to one kind of LED output current and OVP voltage set through the single setting pin.

That is, the LED driving circuit according to the related art may set one kind of LED output current and OVP voltage.

However, the LED driving circuit according to the related art has a problem in that when an LED backlight is used in conjunction with the LED driving circuit, the LED output current and the OVP voltage are inevitably changed. Thus, the corresponding parts of the LED driving circuit need to be changed.

Furthermore, the LED driving circuit according to the related art has difficulties in changing the LED output current and the OVP voltage, in terms of the common use of a board and parts. Therefore, products to which the LED driving circuit can be applied are significantly limited.

### SUMMARY OF THE INVENTION

An aspect of the present invention provides an apparatus for driving a light emitting device which is capable of externally controlling an over-voltage protection (OVP) reference voltage of a light emitting device such as an LED and a current flowing in the light emitting device by setting the voltage and current of the light emitting device from the outside.

According to an aspect of the present invention, there is provided an apparatus for driving a light emitting device including: a current control unit generating a current control signal according to a preset current setting value; a constant current circuit unit varying a current resistance value according to the current control signal of the current control unit, detecting a current flowing in a light emitting unit including a plurality of emitting devices by using the current resistance value, and controlling the current flowing in the light emitting unit based on the detected current; and a voltage control unit varying a voltage resistance value according to a preset voltage setting value, detecting a voltage supplied to the light emitting unit by using the voltage resistance value, and determining whether or not the voltage is in an over-voltage state, based on the detected voltage.

According to another aspect of the present invention, there is provided an apparatus for driving a light emitting device including: a current control unit generating a current control signal according to a preset current setting value; a constant current circuit unit varying a current resistance value according to the current control signal of the current control unit, detecting a current flowing in a light emitting unit including a plurality of emitting devices by using the current resistance value, and controlling the current flowing in the light emitting unit based on the detected current; a voltage control unit varying a voltage resistance value according to a preset voltage setting value, detecting a voltage supplied to the light emitting unit by using the voltage resistance value, and determining whether or not the voltage is in an over-voltage state, based on the detected voltage; a protection circuit unit generating a protection signal when the voltage is determined to be in an over-voltage state by the voltage control unit; and a driving control unit controlling the light emitting unit to be stopped when the protection signal is inputted from the protection circuit unit.

The current setting value may include first and second current setting values.

The current control unit may include: a first comparison section comparing the first current setting value of the current setting value with a plurality of different current reference values and generating a first current comparison value corresponding to the magnitude of the first current setting value; a second comparison section comparing the second current setting value of the current setting value with a plurality of different current reference values and generating a second current comparison value corresponding to the magnitude of the second current setting value; and a logic circuit section performing a logic operation on the first comparison value from the first comparison section and the second comparison value from the second comparison section and generating the current control signal including a plurality of switching signals.

The constant current circuit unit may include a resistance variation section and a current control section. The resistance variation section may include a plurality of resistance variation circuits, each of which includes a plurality of resistors coupled in parallel and a plurality of switches for selecting the respective resistors according to the current control signal from the current control unit, in order to detect currents flowing in the respective emitting devices of the light emitting unit, and the current control section may include a plurality of current control circuits, each of which includes a comparator comparing a detection voltage with a preset reference voltage and providing the voltage difference therebetween and a MOS transistor controlling a current flowing in the corresponding emitting device according to the voltage difference from the comparator, the detection voltage being detected by a current flowing through the corresponding emitting device of the light emitting unit and a resistor selected by the corresponding resistance variation circuit.

The voltage control unit may include: a first comparison section comparing the voltage setting value with a plurality of different voltage reference values and generating an over-voltage setting value corresponding to the magnitude of the voltage setting value; a resistance variation detection section including a plurality of resistors coupled in parallel to a second resistor used for detection, between first and second resistors included in the light emitting unit, and a plurality of switches selecting the respective resistors according to the over-voltage setting value from the first comparison section; and an over-voltage determination section comparing a detection voltage with a preset over-voltage reference value and determining whether or not the voltage supplied to the light emitting unit is in an over-voltage state, the detection voltage being detected by a composite resistor formed by the second resistor of the light emitting unit and the resistor selected by the resistance variation detection section.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of an apparatus for driving a light emitting device according to an embodiment of the present invention;

FIG. 2 is a detailed circuit block diagram of the current control unit according to the embodiment of the present invention;

FIG. 3 is a circuit block diagram of the constant current circuit unit according to the embodiment of the present invention; and

FIG. 4 is a detailed circuit block diagram of the voltage control unit according to the embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. Like reference numerals in the drawings denote like elements, and thus their description will be omitted.

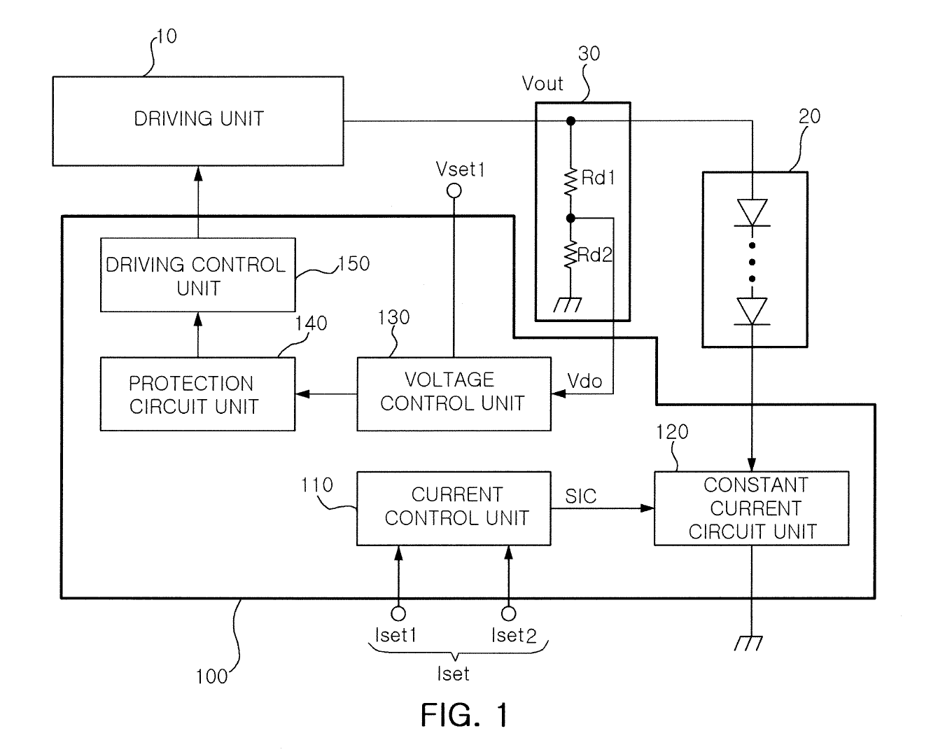

FIG. 1 is a block diagram of an apparatus for driving a light emitting device according to an embodiment of the present invention.

Referring to FIG. 1, the apparatus for driving a light emitting device according to the embodiment of the present invention includes a current control unit 110, a constant current circuit unit 120, and a voltage control unit 130. The current control unit 110 is configured to generate a current control signal SIC according to a preset current setting value Iset. The constant current circuit unit 120 is configured to vary a current resistance value according to the current control signal SIC of the current control unit 110, detect a current flowing in a light emitting unit 20, including a plurality of emitting devices, by using the current resistance value, and control the current flowing in the light emitting unit 20 based on the detected current. The voltage control unit 130 is configured so as to vary a voltage resistance value according to a preset voltage setting value Vset, detect a voltage supplied to the light emitting unit 20 by using the voltage resistance value, and determine whether or not the voltage supplied to the light emitting unit 20 is in an over-voltage state, based on the detected voltage.

The current setting value Iset may include first and second current setting values Iset1 and Iset2.

Furthermore, the apparatus for driving a light emitting device according to the embodiment of the present invention may include a protection circuit unit 140 and a driving control unit 150. The protection circuit unit 140 is configured to generate a protection signal when the voltage is determined to be in an over-voltage state by the voltage control unit 130. The driving control unit 150 is configured to control the light emitting unit 20 to be stopped when the protection signal is inputted from the protection circuit unit 140.

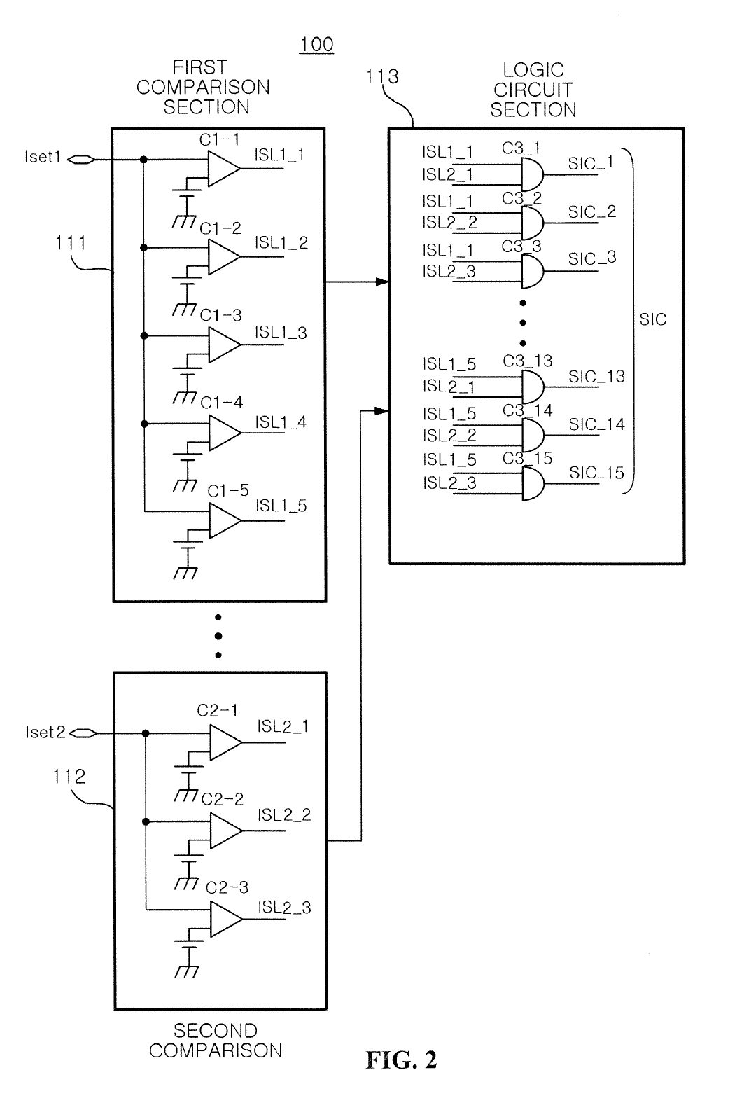

FIG. 2 is a detailed circuit block diagram of the current control unit according to the embodiment of the present invention.

Referring to FIG. 2, the current control unit 110 includes a first comparison section 111, a second comparison section 112, and a logic circuit section 113. The first comparison section 111 is configured to compare the first current setting value Iset1 of the current setting values Iset with a plurality of different current reference values and generate first current comparison values ISL1_1 to ISL1_5, corresponding to the magnitude of the first current setting value Iset1. The second comparison section 112 is configured to compare the second current setting value Iset2 of the current setting values Iset with a plurality of different current reference values and generate second current comparison values ISL2_1 to ISL2_3 corresponding to the magnitude of the second current setting value Iset2. The logic circuit section 113 is configured to perform a logic operation on the first current comparison values ISL1_1 to ISL1_5 from the first comparison section 111 and the second current comparison values ISL2_1 to ISL2_3 from the second comparison section 112 and generate the current control signal SIC including a plurality of switching signals SIC_1 to SIC_15.

Referring to FIG. 2, the first comparison section 111 may include five first to fifth comparators C1-1 to C1-5, and may be configured in such a manner that when different current reference values are set in the first to fifth comparators C1-1 to C1-5, respectively, the first to fifth comparators C1-1 to C1-5 compare the first current setting value Iset1 with the different current reference values and generate the first current comparison values ISL1_1 to ISL1_5 corresponding to the magnitude of the first current setting value Iset1.

The second comparison section 112 may include three first to third comparators C2-1 to C2-3, and may be configured in such a manner that when different current reference values are set in the first to third comparators C2-1 to C2-3, respectively, the first to third comparators C2-1 to C2-3 compare the second current setting value Iset2 with the different current reference values and generate the second current comparison values ISL2_1 to ISL2_3 corresponding to the magnitude of the second current value Iset2.

The logic circuit section 113 may include five first to fifth comparators C3-1 to C3-5. When the second comparator 112 includes three first to third comparators C2-1 to C2-3, the logic circuit section 113 may include 15 first to fifteenth AND gates C3-1 to C3-15. At this time, the first to fifteenth AND gates C3-1 to C3-15 may be configured to output first to fifteenth switching signals SIC_1 to SIC_15, respectively.

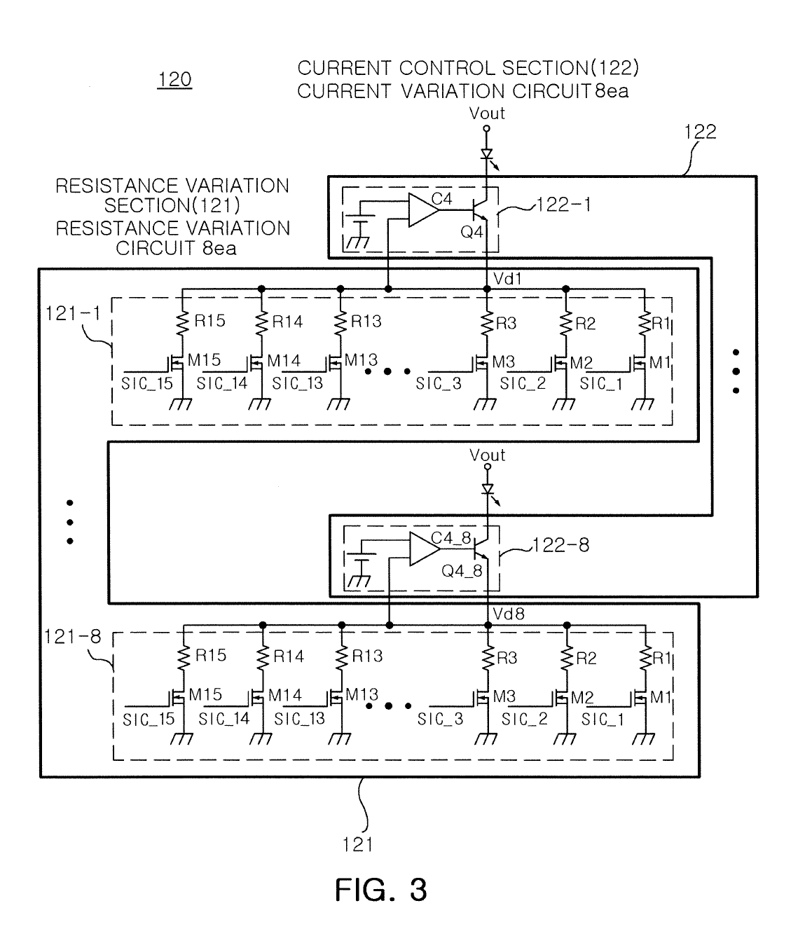

FIG. 3 is a circuit block diagram of the constant current circuit unit according to the embodiment of the present invention.

Referring to FIG. 3, the constant current circuit unit 120 may include a resistance variation section 121 and a current control section 122.

The resistance variation section 121 may include a plurality of resistance variation circuits 121-1 to 121-8, each of which includes a plurality of resistors R1 to R15 coupled in parallel and a plurality of switches M1 to M15 configured to select the respective resistors according to the current control signal SIC from the current control unit 110, in order to detect currents flowing in the respective emitting devices of the light emitting unit 20.

Referring to FIG. 3, the resistance variation section 121 may include eight first to eighth resistance variation circuits 121-1 to 121-8, each of which includes 15 resistors R1 to R15 and 15 switches M1 to M15. The respective switches M1 to M15 may be switched on or off by the first to fifteenth switching signals SIC_1 to CIS_15 from the first to fifteenth AND gates C3-1 to C3-15.

The current control section 122 may include a plurality of current control circuits 121-1 to 121-8, each of which includes a comparator C4 and a MOS transistor Q4. The comparator C4 is configured to compare a corresponding one of detection voltages Vd1 to Vd8 with a preset reference voltage and provide the voltage difference therebetween. The detection voltages Vd1 to Vd8 are detected by currents flowing through the corresponding emitting devices of the light emitting unit 20 and the resistors selected by the resistance variation section 121. The MOS transistor Q4 is configured to control the current flowing in the corresponding emitting device according to the voltage difference from the comparator C4.

Referring to FIG. 3, the comparators C4 and the MOS transistors Q4 of the current control section 122 will be described in more detail.

The comparators C4 may be configured to compare the detection voltage Vd1 to Vd8 with the preset reference voltage and provide the voltage differences therebetween to the bases of the MOS transistors Q4, respectively. The detection voltages Vd1 to Vd8 are detected by currents flowing through the corresponding emitting devices of the light emitting unit 20 and the resistors selected by the resistance variation section 121.

The MOS transistors Q4 may be configured to control the currents flowing in the corresponding emitting devices according to the voltage differences from the comparator C4.

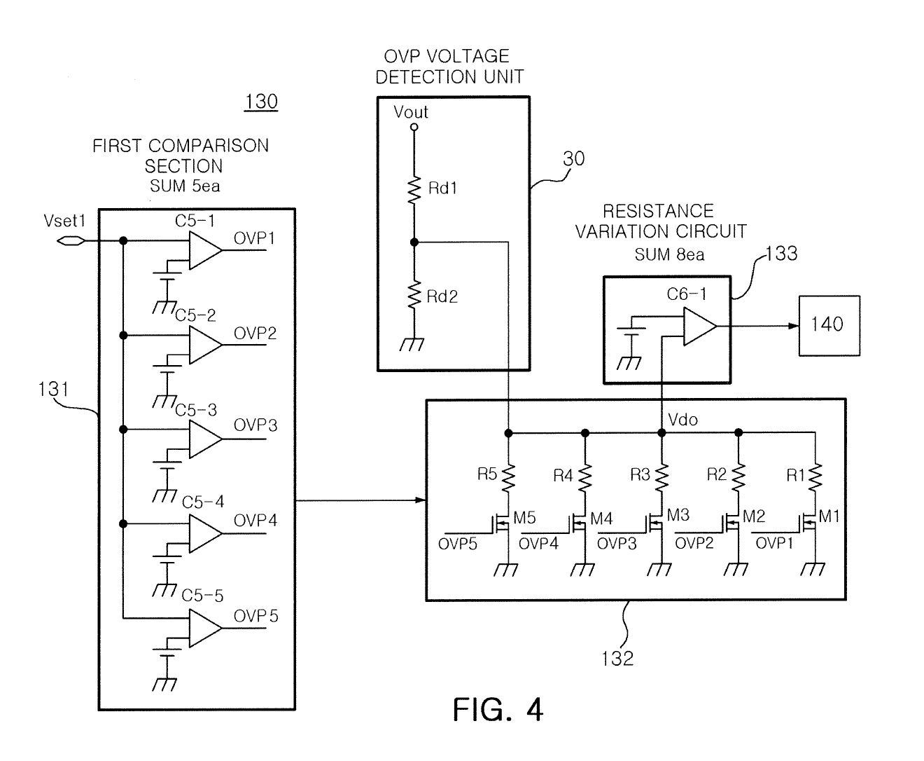

FIG. 4 is a detailed circuit block diagram of the voltage control unit according to the embodiment of the present invention.

Referring to FIG. 4, the voltage control unit 130 may include a first comparison section 131, a resistance variation detection section 132, and an over-voltage determination section 133. The first comparison section 131 is configured to compare a voltage setting value Vset with a plurality of different voltage reference values and generate over-voltage setting values OVP1 to OVP5 corresponding to the magnitude of the voltage setting value Vset1. The resistance variation detection section 132 includes a plurality of resistors R1 to R5 coupled in parallel to a second resistor Rd2 used for detection, between first and second resistors Rd1 and Rd2 included in the light emitting unit 20, and a plurality of switches M1 to M5 configured to select the respective resistors R1 to R5 according to the over-voltage setting values OVP1 to OVP5 from the first comparison section 131. The over-voltage determination section 133 is configured to compare a detection voltage Vdo with a preset over-voltage reference value and determine whether or not the detection voltage is in an over-voltage state. The detection voltage Vdo is detected by a composite resistor formed by the second resistor Rd2 of the light emitting unit 20 and the resistor selected by the resistance variation detection section 132.

Referring to FIG. 4, the first comparison section 131 may include five first to fifth comparators C5-1 to C5-5. At this time, when different voltage reference voltages are set in the first to fifth comparators C5-1 to C5-5 of the first comparison section 131, respectively, the first to fifth comparators C1-1 to C1-5 of the first comparison section 131 compare the voltage setting value Vset with the different voltage reference values and generate the over-voltage setting values OVP1 to OVP5 corresponding to the magnitude of the voltage setting value Vset.

Referring to FIG. 4, the resistance variation detection section 132 may include a plurality of resistors R1 to R5 and a plurality of switches M1 to M5.

At this time, the plurality of switches M1 to M5 of the resistance variation detection section 132 are switched on or off according to the over-voltage setting value OVP1 to OVP5 from the first comparison section 131, and some of the resistors R1 to R5 may be coupled in parallel to the second resistor Rd used for detection, between the first and second resistors Rd1 and Rd2 included in the light emitting unit 20, by on-state switches of the switches M1 to M5.

Referring to FIG. 4, the over-voltage determination section 133 may be configured to compare the detection voltage Vdo with the preset over-voltage reference value and determine whether or not the detection voltage Vdo is in an over-voltage state. The detection voltage Vdo is detected by the composite resistor formed by the second resistor Rd2 of the light emitting unit 20 and the resistor selected by the resistance variation detection section 132.

Hereinafter, the operation and effect of the apparatus for driving a light emitting device according to the embodiment of the present invention will be described with the accompanying drawings.

Referring to FIGS. 1 to 4, the apparatus for driving a light emitting device according to the embodiment of the present invention will be described. In FIG. 1, the current control unit 110 may generate the current control signal SIC according to the preset current setting value Iset. At this time, the current setting value Iset may include the first and second current setting values Iset1 and Iset2.

The constant current circuit unit 120 may vary a current resistance value according to the current control signal SIC of the current control unit 110, detect a current flowing in the light emitting unit 20 including the plurality of emitting devices by using the current resistance value, and control the current flowing in the light emitting unit 20 based on the detected current.

The voltage control unit 130 may vary a voltage resistance value according to the preset voltage setting value Vset, detect a voltage supplied to the light emitting unit 20 by using the voltage resistance value, and determine whether or not the voltage supplied to the light emitting unit 20 is in an over-voltage state, based on the detected voltage.

The protection circuit unit 140 may generate a protection signal when the voltage is determined to be in an over-voltage state by the voltage control unit 130.

The driving control unit 150 may control the light emitting unit 20 to be stopped, when the protection signal is inputted from the protection circuit unit 140.

Referring to FIG. 2, a case in which the current control unit 110 includes the first comparator 111, the second comparator 112, and the logic circuit section 113 will be described.

The first comparator 111 compares the first current setting value Iset1 of the current setting values Iset1 and Iset2 with a plurality of different current reference values and generates the first current comparison values ISL1 to ISL5 corresponding to the magnitude of the first current setting value Iset1.

As a specific example, a case in which the first comparator 111 includes five first to fifth comparators C1-1 to C1-5 will be described with reference to FIG. 2.

Referring to FIG. 2, when different current reference values are set in the first to fifth comparators C1-1 to C1-5, respectively, the first to fifth comparators C1-1 to C1-5 compare the first current setting value Iset1 with the different current reference values and generate the first current comparison values ILS1_5 to ISL1_5 corresponding to the magnitude of the first current setting value Iset1.

For example, when it is assumed that the first current setting value Iset1 is set to 1.2V and the first to fifth current reference values of the first to fifth comparators C1-1 to C1-5 are set to 5V, 4V, 3V, 2V, and 1V, respectively, the first to fifth comparators C1-1 to C1-5 may sequentially output 0(LOW), 0(LOW), 0(LOW), 0(LOW), and 1(HIGH) as logic signals.

The second comparison section 112 may compare the second current setting value Iset2 of the current setting values Iset1 and Iset2 with a plurality of different current reference values and generate the second current comparison values ISL2_1 to ISL2_3 corresponding to the magnitude of the second current setting value Iset2.

As a specific example, a case in which the second comparison section 112 includes three first to third comparators C2-1 to C2-3 will be described with reference to FIG. 2.

Referring to FIG. 2, when different current reference values are set in the first to third comparators C2-1 to C2-3 of the second comparison section 112, respectively, the first to third comparators C2-1 to C2-3 of the second comparison section 112 may compare the second current setting value Iset2 with the different current reference values and generate the second current comparison values ISL2_1 to ISL2_3 corresponding to the magnitude of the second current setting value Iset2.

For example, when the second current setting value Iset2 is set to 1.2V and the first to third current reference values of the first to third comparators C2-1 to C2-3 of the second comparison section 112 are set to 3V, 2V, and 1V, respectively, the first to third comparators C2-1 to C2-3 of the second comparison section 112 may sequentially output 0(LOW), 0(LOW), and 1(HIGH) as logic signals.

The logic circuit section 113 may perform a logic operation on the first current comparison values ISL1 to ISL5 from the first comparison section 111 and the second current comparison values ISL2_1 to ISL2_3 from the second comparison section 112 and generate the current control signal SIC including the plurality of switching signals SIC_1 to SIC_15.

As a specific example, when the first comparison section 111 includes five first to fifth comparators C1-1 to C1-5 and the second comparison section 112 includes three first to third comparators C2-1 to C2-3, the logic circuit section 113 may include 15 first to fifteenth AND gates C3-1 to C3-15. At this time, the first to fifteenth AND gates C3-1 to C3-15 may output the first to fifteen switching signals SIC_1 to SIC_15, respectively.

For example, when the first to fifth comparators C1-1 to C1-5 of the first comparison section 111 sequentially output 0(LOW), 0(LOW), 0(LOW), 0(LOW), and 1(HIGH) as logic signals and the first to third comparators C2-1 to C2-3 of the second comparison section 112 sequentially outputs 0(LOW) 0(LOW), and 1(HIGH) as logic signals, the first to fifteenth switching signals SIC_1 to SIC_15 of the first to fifteenth AND gates C3-1 to C3-15 coupled as illustrated in FIG. 2 may become 0, 0, 0, . . . , 0, 0, and 1.

Referring to FIG. 3, a case in which the constant current circuit unit 120 includes the resistance variation section 121 and the current control section 122 will be described.

Referring to FIG. 3, the resistance variation section 121 may include the plurality of resistance variation circuits 121-1 to 121-8, each of which includes the plurality of resistors R1 to R15 and a plurality of switches M1 to M15.

The plurality of switches M1 to M15 included in each of the resistance variation circuits 121-1 to 121-8 are switched on or off by the plurality of switching signals SIC_1 to SIC_15 from the logic circuit section 113, and resistors coupled to on-state switches among the plurality of switches M1 to M15 are coupled in parallel to each other to decide the entire equivalent resistance.

For example, when the resistance variation section 121 include eight first to eighth resistance variation circuits 121-1 to 121-8 and each of the first to eighth resistance variation circuits 121-1 to 121-8 includes 15 resistors R1 to R15 and 15 switches M1 to M15, the respective switches M1 to M15 are switched on or off by the first to fifteenth switching signals SIC_1 to SIC_15 from the first to fifteenth AND gates C3-1 to C3-15 of the logic circuit section 113, respectively.

Among the 15 resistors, resistors selected by on-state switches of the 15 switches M1 to M15 are coupled in parallel to decide the entire resistance value.

Next, a case in which the current control section 122 includes the comparator C4 and the MOS transistor Q4 will be described.

The comparator C4 compares a corresponding one of the detection voltages Vd1 to Vd8 with a preset reference voltage, and provides the voltage difference therebetween to the base of the MOS transistor Q4. The detection voltages Vd1 to Vd8 are detected by currents flowing through the corresponding emitting devices of the light emitting unit 20 and the resistors selected by the resistance variation section 121.

At this time, the MOS transistor Q4 may control a current flowing in the corresponding light emitting device according to the voltage difference from the comparator C4.

According to the above description, the current flowing in the light emitting unit 20 may be controlled outside by the current control section 121 and the constant current circuit section 122.

Referring to FIG. 4, a case in which the voltage control unit 130 includes the first comparison section 131, the resistance variation detection section 132, and the over-voltage determination section 133 will be described.

Referring to FIG. 4, the first comparison section 131 may compare the voltage setting voltage Vset with a plurality of different voltage reference values and generate the over-voltage setting values OVP1 to OVP5 corresponding to the magnitude of the voltage setting value Vset1.

As a specific example, a case in which the first comparison section 131 includes five first to fifth comparators C5-1 to C5-5 will be described with reference to FIG. 4.

Referring to FIG. 4, when different voltage reference values are set in the first to fifth comparators C5-1 to C5-5 of the first comparison section 131, respectively, the first to fifth comparators C1-1 to C5-5 of the first comparison section 131 may compare the voltage setting value Vset with the different voltage reference values and generate the over-voltage setting values OVP1 to OVP5 corresponding to the magnitude of the voltage setting value Vset.

For example, when the voltage setting value is set to 1.2V and the first to fifth voltage reference values of the first to fifth comparators C1-1 to C1-5 of the first comparison section 113 are set to 5V, 4V, 3V, 2V, and 1V, respectively, the first to fifth comparators C1-1 to C1-5 of the first comparison section 113 may sequentially output 0(LOW), 0(LOW), 0(LOW), 0(LOW), and 1(HIGH) as logic signals.

Next, a case in which the resistance variation detection section 132 includes the plurality of resistors R1 to R5 and the plurality of switches M1 to M5 will be described with reference to FIG. 4.

Referring to FIG. 5, the plurality of switches M1 to M5 of the resistance variation detection section 132 are switched on or off according to the over-voltage setting values OVP1 to OVP5 from the first comparison section 131, and some resistors among the plurality of resistors R1 to R5 are coupled in parallel to the second resistor Rd2 used for detection, between the first and second resistors Rd1 and Rd2 included in the light emitting unit 20, by on-state switches among the plurality of switches M1 to M5.

Through the above-described process, the resistance value for detecting a voltage supplied to the light emitting unit 20 may be decided according to the external control.

Then, the over-voltage determination section 133 may compare the detection voltage Vdo with a preset over-voltage reference value and determine whether or not the detection voltage Vdo is in an over-voltage state. The detection voltage Vdo is detected by a composite resistor formed by the second resistor Rd2 of the light emitting unit 20 and the resistor selected by the resistance variation detection section 132.

Accordingly, in order to determine whether or not the voltage supplied to the light emitting unit 20 is in an over-voltage state, the detection resistance for detecting the voltage may be controlled. Therefore, the voltage level for the over-voltage determination may be controlled outside.

According to the embodiment of the present invention, the OVP reference voltage and the current flowing in the light emitting device such as an LED may be externally controlled by setting the voltage and current of the light emitting device from outside. Therefore, it is possible to extend the range of products to which the apparatus for driving alight emitting device is applied.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for driving a light emitting device, comprising:
a current control unit generating a current control signal according to a preset current setting value;
a constant current circuit unit varying a current resistance value according to the current control signal of the current control unit, detecting a current flowing in a light emitting unit comprising a plurality of emitting devices by using the current resistance value, and controlling the current flowing in the light emitting unit based on the detected current; and
a voltage control unit varying a voltage resistance value according to a preset voltage setting value, detecting a voltage supplied to the light emitting unit by using the voltage resistance value, and determining whether or not the voltage is in an over-voltage state, based on the detected voltage.

2. The apparatus of claim 1, wherein the current setting value comprises first and second current setting values, and the current control unit comprises:
a first comparison section comparing the first current setting value of the current setting value with a plurality of different current reference values and generating a first current comparison value corresponding to the magnitude of the first current setting value;
a second comparison section comparing the second current setting value of the current setting value with a plurality of different current reference values and generating a second current comparison value corresponding to the magnitude of the second current setting value; and
a logic circuit section performing a logic operation on the first comparison value from the first comparison section and the second comparison value from the second comparison section and generating the current control signal comprising a plurality of switching signals.

3. The apparatus of claim 2, wherein the constant current circuit unit comprises a resistance variation section and a current control section,
the resistance variation section comprises a plurality of resistance variation circuits, each of which comprises a plurality of resistors coupled in parallel and a plurality of switches for selecting the respective resistors according to the current control signal from the current control unit, in order to detect currents flowing in the respective emitting devices of the light emitting unit, and
the current control section comprises a plurality of current control circuits, each of which comprises a comparator comparing a detection voltage with a preset reference voltage and providing the voltage difference therebetween and a MOS transistor controlling a current flowing in the corresponding emitting device according to the voltage difference from the comparator, the detection voltage being detected by a current flowing through the corresponding emitting device of the light emitting unit and a resistor selected by the corresponding resistance variation circuit.

4. The apparatus of claim 3, wherein the voltage control unit comprises:
a first comparison section comparing the voltage setting value with a plurality of different voltage reference values and generating an over-voltage setting value corresponding to the magnitude of the voltage setting value;
a resistance variation detection section comprising a plurality of resistors coupled in parallel to a second resistor used for detection, between first and second resistors included in the light emitting unit, and a plurality of switches selecting the respective resistors according to the over-voltage setting value from the first comparison section; and
an over-voltage determination section comparing a detection voltage with a preset over-voltage reference value and determining whether or not the voltage supplied to the light emitting unit is in an over-voltage state, the detection voltage being detected by a composite resistor formed by the second resistor of the light emitting unit and the resistor selected by the resistance variation detection section.

5. An apparatus for driving a light emitting device, comprising:
a current control unit generating a current control signal according to a preset current setting value;
a constant current circuit unit varying a current resistance value according to the current control signal of the current control unit, detecting a current flowing in a light emitting unit comprising a plurality of emitting devices by using the current resistance value, and controlling the current flowing in the light emitting unit based on the detected current;
a voltage control unit varying a voltage resistance value according to a preset voltage setting value, detecting a voltage supplied to the light emitting unit by using the voltage resistance value, and determining whether or not the voltage is in an over-voltage state, based on the detected voltage;
a protection circuit unit generating a protection signal when the voltage is determined to be in an over-voltage state by the voltage control unit; and
a driving control unit controlling the light emitting unit to be stopped when the protection signal is inputted from the protection circuit unit.

6. The apparatus of claim 5, wherein the current setting value comprises first and second current setting values, and
the current control unit comprises:
a first comparison section comparing the first current setting value of the current setting value with a plurality of different current reference values and generating a first current comparison value corresponding to the magnitude of the first current setting value;
a second comparison section comparing the second current setting value of the current setting value with a plurality of different current reference values and generating a second current comparison value corresponding to the magnitude of the second current setting value; and
a logic circuit section performing a logic operation on the first comparison value from the first comparison section and the second comparison value from the second comparison section and generating the current control signal comprising a plurality of switching signals.

7. The apparatus of claim 6, wherein the constant current circuit unit comprises a resistance variation section and a current control section,
the resistance variation section comprises a plurality of resistance variation circuits, each of which comprises a plurality of resistors coupled in parallel and a plurality of switches for selecting the respective resistors according to the current control signal from the current control unit, in order to detect currents flowing in the respective emitting devices of the light emitting unit, and
the current control section comprises a plurality of current control circuits, each of which comprises a comparator comparing a detection voltage with a preset reference voltage and providing the voltage difference therebetween and a MOS transistor controlling a current flowing in the corresponding emitting device according to the voltage difference from the comparator, the detection voltage being detected by a current flowing through the corresponding emitting device of the light emitting unit and a resistor selected by the corresponding resistance variation circuit.

8. The apparatus of claim 7, wherein the voltage control unit comprises:
a first comparison section comparing the voltage setting value with a plurality of different voltage reference values and generating an over-voltage setting value corresponding to the magnitude of the voltage setting value;
a resistance variation detection section comprising a plurality of resistors coupled in parallel to a second resistor used for detection, between first and second resistors included in the light emitting unit, and a plurality of switches selecting the respective resistors according to the over-voltage setting value from the first comparison section; and
an over-voltage determination section comparing a detection voltage with a preset over-voltage reference value and determining whether or not the voltage supplied to the light emitting unit is in an over-voltage state, the detection voltage being detected by a composite resistor formed by the second resistor of the light emitting unit and the resistor selected by the resistance variation detection section.
